(19) United States
(12) Patent Application Publication
(10) Pub. No.: US 2025/0078789 A1
(43) Pub. Date: Mar. 6, 2025

(54) Python Program to Parse Music XML files and Verbally Output Note Description for Reading Music

(71) Applicant: Anika Gupta, Portland, OR (US)

(72) Inventor: Anika Gupta, Portland, OR (US)

(21) Appl. No.: 18/462,352

(22) Filed: Sep. 6, 2023

(51) Int. Cl. G10G 1/02; G06F 40/221; G10L 13/02

(52) U.S. Cl. CPC G10G 1/02; G06F 40/221; G10L 13/02

(57) ABSTRACT

The method disclosed utilizes Python code. The Python program reads in Music XML through .txt files and parses the file. Depending on the values of the note name, octave, and alter, the corresponding note (a letter from A-G) is announced along with the octave number (an integer from 1-7) and any alter, if applicable (sharp or flat). The note's type (quarter, eighth, or half) is taken into account to issue a corresponding pause between the announcements of distinct notes.

### CROSS-REFERENCE TO RELATED APPLICATIONS

Not applicable

### BACKGROUND OF THE INVENTION

The field of invention is music and computer science. This program was created to aid the visually impaired with reading music. The program allows the user to simultaneously listen to the music score and play the instrument rather than memorizing the braille score beforehand.

### BRIEF SUMMARY OF THE INVENTION

The invention is a Python program that parses through Music XML files and outputs an audio version to aid with reading music. The audio output contains the letter name of each note, along with the note's octave, and whether it is flat or sharp, if applicable. It also takes into consideration the length of each note (for instance, quarter note versus eighth note) and the tempo to adjust the speed of the program.

### BRIEF DESCRIPTION OF THE SEVERAL VIEWS OF THE DRAWING

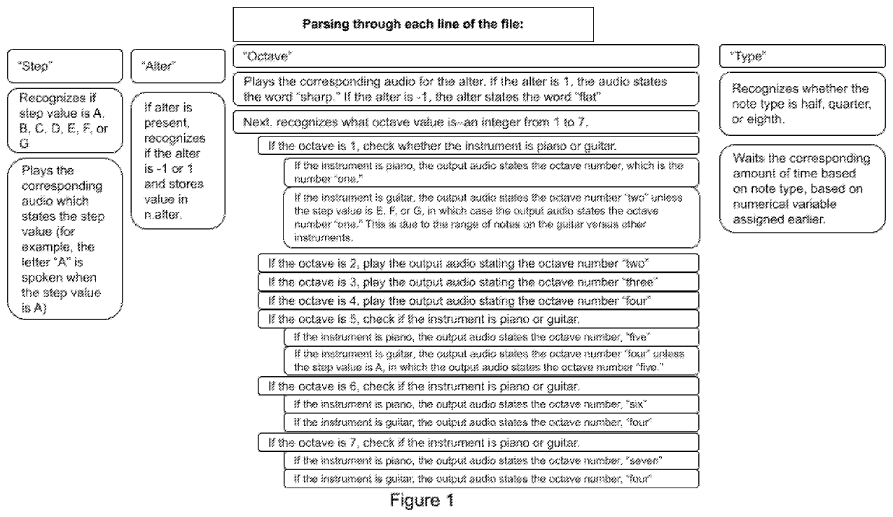

The drawing (FIG. 1) is a flowchart which describes the process that the Python program goes through when analyzing each line of the file that it reads in and how it determines the output audios.

### DETAILED DESCRIPTION OF THE INVENTION

The program is written in Python. The program opens a .txt file and creates a path to it. The user copy pastes the text in the Music XML file into the .txt file.

A class “Note” is created which contains variables to store the step (letter note, eg A), alter (whether it's flat or sharp, −1 for flat, 0 for unaltered, and 1 for sharp), the integer octave, and the note type (as in, quarter note, eighth note, etc.).

In the main class, a variable keeps track of the instrument, either guitar or piano. A new note n is created. There is also a string variable “delims” which contains “[< >}+”. A variable called quarterNote is assigned the value of 1.5 and is intended to be changed by the user if desired; it is a method of keeping track of the time signature and tempo. A variable keeps track of whether the note is filled or empty.

There is an if statement that checks if the note is filled. If it is empty, then a for loop iterates through each line of the file.

There are multiple if statements within this for loop that check for keywords in each line of the file. The keywords are ‘step’, ‘alter’, ‘octave’, and ‘type’. If any of the keywords are found in the current line that is being read, then the delims characters that are in the current line are replaced with null.

Additionally, within each if statement that check for the keywords, there are more if statements to sort the information.

If the keyword ‘step’ is in the line, then there is an if statement to check if the step value is “A.” If the value is A, then the program outputs a .wav audio file which states the letter A. Following this if statement is 6 elif statements which check if the step value is B, C, D, E, F, or G. Depending on what letter it is, the program outputs a .wav audio file which states the letter name. Additionally, n.step is set to the letter value of the note.

If the keyword ‘alter’ is in the line, then n.alter is set to the alter value (can be either −1 or 1).

If the keyword ‘octave’ is in the line, then the alter audio file first runs here. There is an if statement to check if the n.alter is 1. If the alter is 1, then an audio file that states the word “sharp” is run. Elif the n.alter value is −1, then the audio file plays that states the word “flat.”

After that, within the if statement that checks for keyword ‘octave,’ there is an if statement that checks if the octave number is 1. If it is, then there is an if statement that checks if the instrument variable is set to piano. If it is, then the program plays an audio that states the number 1. This means that the octave to be played is octave one. There is an elif statement that checks if the instrument is guitar. If the instrument is guitar, then there is another if statement to check the n.step value. If the n.step note is E, F, or G, then the program plays an audio that states the number 1 because octave 1 can be played. However, there is an else statement below that (meaning that the note is not E, F, or G), and in this case the program plays an audio that states the number 2, meaning that octave 2 should be played. The reasoning behind this is that the standard tuning of guitar doesn't have the same notes as the piano and therefore some notes from certain octaves cannot be played so they must be shifted to a higher octave.

After the if statement that checks if the octave number is 1, there is an elif statement to check if the octave number is octave 2, 3, or 4. Within each of these elif statements, the program outputs the octave number, so if the octave number is 3, then the program will output a .wav audio file that states the number 3.

Below that is an elif statement to check if the octave number is 5. If the octave number is five, there is an if statement to check if the instrument is piano, and if it is, then it outputs an audio file that states the number 5. Else, the program has an if statement to check if the n.step note is A. If the note is A, then the audio file that states the number 5 is played to play in octave 5. Else, the program plays the audio which states the octave number to be 4. This is because, other than piano, some instruments do not have notes in octave 5, and therefore octave 4 should be played. This similar reasoning applies to the two elif statements below this, which check if the octave number is 6 or 7. Within these elif statements, the program checks whether the instrument is piano or guitar. If the instrument is piano, then the program outputs an audio file that states the number 6 for octave 6 and 7 for octave 7. However, if the instrument is guitar, then the program plays the audio file that states the number 4, so the user should play in octave 4.

After the entire if statement to check for the octave, there is an if statement to check if the keyword is “type.” If the keyword is type, there are three if statements to check if the n.type is half, quarter, or eighth. Then, the time.sleep function is used to create a pause. If n.type is ‘half,’ then the program will sleep for the quarterNote variable*2. If n.type is quarter, the program will sleep for variable quarterNote. If n.type is eighth, the program will sleep for quarterNote/2.

Then, the filled variable will be set to full because all aspects of the note have been outputted as an audio and saved. Then, the note will be emptied and filled will be set to empty again so the program can go through the next notes.

This program was written on the Pycharm IDE. To use this program, you would need to put the desired music XML file into the .txt file on the local device where the program creates a path to (The user copy pastes the text in the Music XML file into the .txt file). After this, the user also can set a desired value to the variable quarterNote-however the current value, 1.5, is suggested for learning new songs. Then, the user can click the run button in the top right corner of the Pycharm app and start playing their instrument along with the program. The program periodically outputs the note as a verbal command. For example, the program may say “A flat 3.” If this is the case, the user plays A flat on octave 3 on the instrument. There will be a pause in the program to allow the user to play the note and corresponding to the length of the note. After that, the next note will be stated verbally. For instance, “B sharp 2.” The user would play B sharp in octave 2 on their instrument. This would continue until the program reaches the end of the file, and then it would automatically terminate. The user can simply click the run button again if they would like to repeat the process, or put a different Music XML file into the .txt file if they would like to play another song.

The intention of this program is to ease the process of learning new music pieces, especially for those with visual impairment. This is because those with visual impairment use Braille scores to read music. Because braille requires physical contact for the user, they cannot simultaneously read the Braille score and play the instrument. Instead, the user would have to memorize the Braille score before playing the song. However, those without visual impairment are able to read normal scores and simultaneously play the instrument, which significantly eases the learning process for learning and reading through songs. With this program, the user can be learning the notes of the music piece while playing it.

1. A program that parses through Music XML files and converts the “step” value to a verbally announced letter name, converts the “alter” value to the verbally announced terms either “sharp” or “flat,” converts the “octave” value to a verbally announced integer from 1 to 7 and uses the “type” value to create a corresponding pause in the verbal announcement of the “step,” “alter,” and “octave” values mentioned above.
